(19) United States
(12) Patent Application Publication
(10) Pub. No.: US 2019/0234363 A1
(43) Pub. Date: Aug. 1, 2019

(54) High-Pressure Port For A High-Pressure Fuel Pump Of A Fuel Injection System

(71) Applicant: CPT Group GmbH, Hannover (DE)

(72) Inventor: Max Scheller, Stamsried (DE)

(73) Assignee: CPT Group GmbH, Hannover (DE)

(21) Appl. No.: 16/258,940

(22) Filed: Jan. 28, 2019

(30) Foreign Application Priority Data
Jan. 29, 2018 (DE) 10 2018 201 279.2

(51) Int. Cl. F02M 63/02; F02D 41/38; F02M 59/36

(52) U.S. Cl. CPC F02M 63/0225; F02D 41/3845; F02D 2200/0614; F02D 2200/0602; F02M 59/361

(57) ABSTRACT

Various embodiments include a high-pressure port for a high-pressure fuel pump of a fuel injection system comprising: an outlet valve with an outlet valve element opening in a first direction and cooperating with an outlet valve seat to close the outlet valve; and a pressure-limiting valve with a pressure-limiting valve element opening in a second direction opposite the first direction and cooperating with a pressure-limiting valve seat to close the pressure-limiting valve. The outlet valve element comprises the pressure-limiting valve seat.

### CROSS-REFERENCE TO RELATED APPLICATIONS

This application claims priority to DE Application No. 10 2018 201 279.2 filed Jan. 29, 2018, the contents of which are hereby incorporated by reference in their entirety.

### TECHNICAL FIELD

The present disclosure relates to fuel injection. Various embodiments may include a high-pressure port for a high-pressure fuel pump of a fuel injection system and a high-pressure fuel pump which has such a high-pressure port.

### BACKGROUND

In common-rail fuel injection systems, the generation of pressure in a fuel that is to be burned in an internal combustion engine and the injection of the fuel into combustion chambers of the internal combustion engine are decoupled. In the process, a high-pressure fuel pump compresses the fuel fed to it from a low-pressure region, for example from a tank. At the outlet side of the high-pressure fuel pump, a volume flow of the compressed fuel then flows to a high-pressure region, for example to a high-pressure accumulator, known as the common rail, from where the compressed fuel is then injected into the combustion chambers of the internal combustion engine.

The high-pressure fuel pump generates a pressure in a range from 150 bar to 400 bar for example when the fuel is gasoline, and a pressure in a range from 1500 bar to 3000 bar when the fuel is diesel. The respective fuel is present in the high-pressure region at this generated high pressure and is fed for example from the high-pressure accumulator to the combustion chambers of the internal combustion engine via injection valves.

In order to ensure the correct functioning of the fuel injection system, and potentially to be able to satisfy specific requirements, a fuel injection system generally has at least two valves, namely an outlet valve and a pressure-limiting valve. The outlet valve acts as a high-pressure valve which opens during an upward movement of a pump piston in a pressure chamber—if the high-pressure fuel pump is embodied as a piston pump—such that the fuel can be delivered into the high-pressure region. During the downward movement of the pump piston, the outlet valve closes, such that a return flow of the compressed fuel from the high-pressure region back into the pressure chamber is prevented.

The pressure-limiting valve has the function of preventing an excessive pressure increase in the high-pressure region, in particular in the high-pressure accumulator. If the pressure in the high-pressure region exceeds a particular value, a certain volume flow of the fuel is discharged either into the pressure chamber of the high-pressure fuel pump or into the low-pressure region via the pressure-limiting valve. In known applications, each of the abovementioned valves—outlet valve and pressure-limiting valve—is installed for example separately in a housing of the high-pressure fuel pump. As a result, a very large installation space is necessary, which results in a large dead space volume, with the result that an efficiency of the high-pressure fuel pump drops.

Alternatively, it is also known for example to provide the pressure-limiting valve and the outlet valve in series with one another in a common housing, but this gives rise to inconstant conduction of the fuel via multiple changes in direction and can also give rise to an undesired drop in pressure and a reduction in the durability as result of cavitation and erosion. It is also known to provide both valves together in a high-pressure port of the high-pressure fuel pump, via which the high-pressure fuel pump is connected to the high-pressure region.

### SUMMARY

The teachings of the present disclosure describe an improved high-pressure port for a high-pressure fuel pump, which has both the outlet valve and the pressure-limiting valve. For example, some embodiments include a high-pressure port (22) for a high-pressure fuel pump (18) of a fuel injection system (10), having: an outlet valve (34) having an outlet valve element (38) that opens in a first direction (R₁) and that cooperates with an outlet valve seat (48) in order to close the outlet valve (34); and a pressure-limiting valve (36) having a pressure-limiting valve element (40) that opens in a second direction (R₂) opposite to the first direction (R₁) and that cooperates with a pressure-limiting valve seat (56) in order to close the pressure-limiting valve (36); wherein the outlet valve element (38) forms the pressure-limiting valve seat (56).

In some embodiments, the outlet valve (34) and the pressure-limiting valve (36) are arranged coaxially one after the other in the high-pressure port (22).

In some embodiments, the outlet valve seat (48) is formed in a valve plate (50) which is fastened in particular in a manner pressed into the high-pressure port (22), wherein the valve plate (50) has a central passage opening (52), which is closed by the outlet valve element (38) in a closed position of the outlet valve element (38).

In some embodiments, the outlet valve element (38) has a central flow-through opening (58), which is closed by the pressure-limiting valve element (40) in a closed position of the pressure-limiting valve element (40), wherein the passage opening (52) in the valve plate (50) has in particular a larger diameter than the flow-through opening (58) in the outlet valve element (38).

In some embodiments, an outlet valve compression spring (60) for preloading the outlet valve element (38) onto the outlet valve seat (48) and a pressure-limiting valve compression spring (64) for preloading the pressure-limiting valve element (40) onto the pressure-limiting valve seat (56) are provided, wherein the outlet valve compression spring (60) and the pressure-limiting valve compression spring (64) are arranged coaxially and one after the other, wherein a support plate (66) on which the outlet valve compression spring (60) and the pressure-limiting valve compression spring (64) are supported is arranged between the outlet valve compression spring (60) and the pressure-limiting valve compression spring (64).

In some embodiments, the outlet valve compression spring (60) is supported on a shoulder (62) in the high-pressure port (22) and the pressure-limiting valve compression spring (64) is supported on the outlet valve element (38).

In some embodiments, the pressure-limiting valve compression spring (64) has a greater spring force (F) than the outlet valve compression spring (60), wherein in particular the pressure-limiting valve compression spring force (F) is large enough for the pressure-limiting valve compression spring (64) to keep the outlet valve element (38) and the support plate (66) at a constant spacing (d) in the case of a pressure difference, acting via the outlet valve (34), of up to 100 bar.

In some embodiments, the pressure-limiting valve element (40) is arranged opposite the pressure-limiting valve compression spring (64) and the outlet valve compression spring (60) with regard to the outlet valve element (38) and is coupled to the support plate (66) by a pin (68) that engages through the outlet valve element (38).

As another example, some embodiments include a high-pressure fuel pump (18) for applying high pressure to a fuel (12) in a fuel injection system (10) of an internal combustion engine, having a pump housing (24), in which high pressure is applied to the fuel (12), and a high-pressure port (22) as described above and fastened to the pump housing (24).

### BRIEF DESCRIPTION OF THE DRAWINGS

Teachings of the present disclosure are explained in more detail in the following text on the basis of the appended drawings, in which:

FIG. 1 shows a schematic overview illustration of a fuel injection system having a high-pressure fuel pump and a high-pressure accumulator, between which a high-pressure port is arranged, incorporating teachings of the present disclosure;

FIG. 2 shows a cross-sectional illustration of the high-pressure port from FIG. 1 as seen from the high-pressure accumulator;

FIG. 3 shows a view of the high-pressure port from FIG. 2 in longitudinal section along the line III-III; and

FIG. 4 shows a view of the high-pressure port from FIG. 2 in longitudinal section along the line IV-IV.

### DETAILED DESCRIPTION

In some embodiments, high-pressure port for a high-pressure fuel pump of a fuel injection system has an outlet valve having an outlet valve element that opens in a first direction and that cooperates with an outlet valve seat in order to close the outlet valve, and a pressure-limiting valve having a pressure-limiting valve element that opens in a second direction opposite to the first direction and that cooperates with a pressure-limiting valve seat in order to close the pressure-limiting valve. In this case, the outlet valve element forms the pressure-limiting valve seat. Since the outlet valve element fulfills two functions, namely the forming of the closing element for the outlet valve and the forming of the valve seat for the pressure-limiting valve, a valve arrangement is provided, which is very compact as an entire assembly and therefore takes up a minimum amount of installation space in the high-pressure port. As a result, the dead space volume of the valve arrangement can be reduced considerably compared with known arrangements.

In some embodiments, the outlet valve and the pressure-limiting valve are arranged coaxially one after the other in the high-pressure port. As a result of the coaxial arrangement, the fuel is conducted linearly through the valve arrangement, and so there is no great change in direction in the flow of the fuel, which could result in an undesired pressure drop and cavitation.

In some embodiments, the outlet valve seat is formed in a valve plate which is fastened in particular in a manner pressed into the high-pressure port. The valve plate has a central passage opening, which is closed by the outlet valve element in a closed position of the outlet valve element.

In some embodiments, the outlet valve element has a central flow-through opening, which is closed by the pressure-limiting valve element in a closed position of the pressure-limiting valve element. The passage opening in the valve plate has a larger diameter than the flow-through opening in the outlet valve element.

The pressure difference that prevails between a high-pressure region of the fuel injection system and a pressure chamber in the high-pressure fuel pump is very different in order to open the two valves. The outlet valve opens typically at a pressure difference of between 10 bar and 50 bar, in order in this way to generate as little resistance as possible and thus also to increase the efficiency of the high-pressure fuel pump. The aim here is to keep the pressure difference as small as possible.

By contrast, the pressure-limiting valve should open only in an emergency and thus at a pressure difference of 300 bar to 400 bar. To meet these different requirements, it is possible for the respectively flowed through cross section when each particular valve is opened to be adapted. Therefore, the flow cross sections at the outlet valve are generally greater by a multiple than at the pressure-limiting valve. This is predominantly realized in that the flow-through opening, which is cleared in order to open the pressure-limiting valve, is arranged in the outlet valve element, which closes the passage opening for the outlet valve. As a result, the flow cross section of the pressure-limiting valve is much smaller than the flow cross section of the outlet valve element. The pressure-limiting valve is thus integrated into the outlet valve and the smallest possible common installation space can be realized.

In some embodiments, an outlet valve compression spring for preloading the outlet valve element onto the outlet valve seat and a pressure-limiting valve compression spring for preloading the pressure-limiting valve element onto the pressure-limiting valve seat are provided, wherein the outlet valve compression spring and the pressure-limiting valve compression spring are arranged coaxially and one after the other, wherein a support plate on which the outlet valve compression spring and the pressure-limiting valve compression spring are supported is arranged between the outlet valve compression spring and the pressure-limiting valve compression spring.

So the acting forces can be applied separately to the outlet valve element and the pressure-limiting valve element, a support plate, which separates the two spring structures from one another and on which the two springs are supported in each case with one end, is arranged between the outlet valve compression spring and the pressure-limiting valve compression spring. In some embodiments, the outlet valve compression spring is supported with the other end on a shoulder in the high-pressure port and the pressure-limiting valve compression spring is supported with the other end on the outlet valve element.

In some embodiments, the pressure-limiting valve compression spring has a greater spring force than the outlet valve compression spring, wherein the pressure-limiting valve compression spring force is large enough for the pressure-limiting valve compression spring to keep the outlet valve element and the support plate at a constant spacing in the case of a pressure difference, acting via the outlet valve, of up to 100 bar.

In some embodiments, the pressure-limiting valve compression spring is supported at one end on the outlet valve element and at the other end on the support plate. Its spring force is large enough that the usual pressure difference that results in the outlet valve opening does not bring about any change in length of the pressure-limiting valve compression spring. As a result, the opening pressure of the outlet valve is determined only via a spring force of the outlet valve compression spring but not via a spring force of the pressure-limiting valve compression spring.

In some embodiments, the pressure-limiting valve element is arranged opposite the pressure-limiting valve compression spring and the outlet valve compression spring with regard to the outlet valve element and is coupled to the support plate by a pin that engages through the outlet valve element. In this case, the pin is preferably formed in one piece with the pressure-limiting valve element and is connected to the support plate for example via a press-fit assembly, via welding, screwing or crimping. The pin is arranged preferably coaxially with the pressure-limiting valve compression spring and the outlet-valve compression spring within the pressure-limiting valve compression spring.

As a result of the provision of the pin, it is possible, in order to preload the pressure-limiting valve element onto the pressure-limiting valve seat, to shift the pressure-limiting valve compression spring onto the side of the high-pressure region and into the high-pressure port. The high-pressure port thus accommodates all the components of both valves, and the smallest possible installation space for the provision of the pressure-limiting valve and outlet valve can be achieved.

In some embodiments, to this end, the high-pressure port also has a line bore, which has lateral recesses in order in this way to realize a fluid line both for the outlet valve and for the pressure-limiting valve in a common line. This results in a line bore in the high-pressure port, which has bore regions with a larger diameter and bore regions with a smaller diameter. In a bore region with a smaller diameter, a stop for the outlet valve element has been pressed in, said stop engaging around the pressure-limiting valve compression spring. This stop limits the movement of the outlet valve element.

In some embodiments, a high-pressure fuel pump for applying high pressure to a fuel in a fuel injection system of an internal combustion engine has a pump housing, in which high pressure is applied to the fuel, and a high-pressure port as described above, which is fastened to the pump housing. The high-pressure port in this case has the outlet valve and the pressure-limiting valve. The two valves can be realized as a cartridge valve structure and be introduced subsequently into the high-pressure port, or the high-pressure port is configured such that it directly accommodates all the individual elements of the outlet valve and of the pressure-limiting valve as a housing.

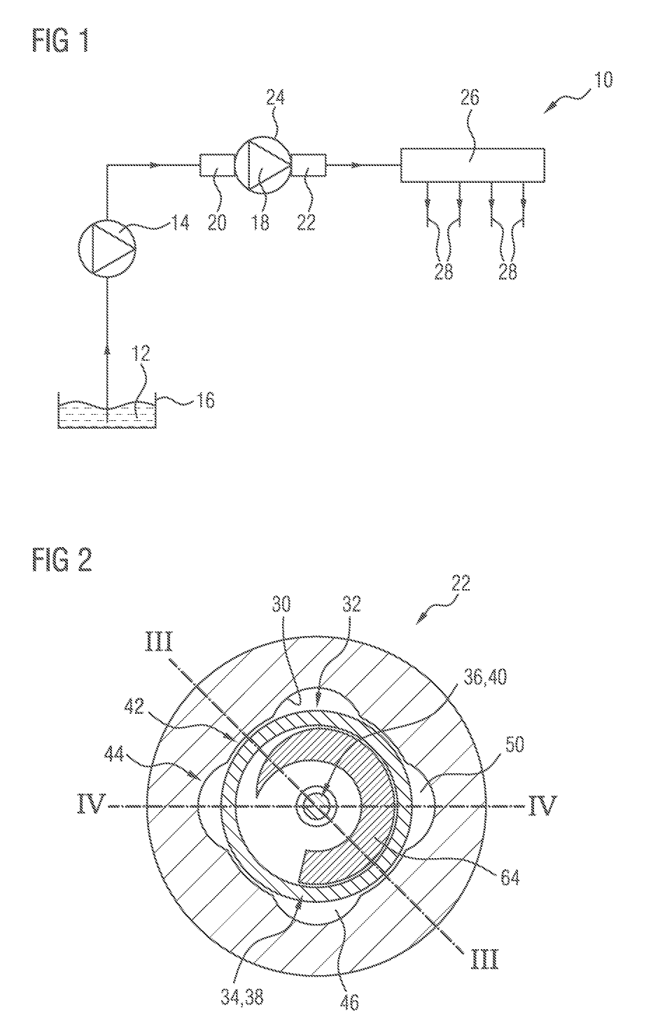

FIG. 1 shows a schematic overview illustration of a fuel injection system 10 incorporating the teachings herein, in which a fuel 12 is delivered by a predelivery pump 14 from a tank 16 to a high-pressure fuel pump 18. High pressure is applied to the fuel 12 in the high-pressure fuel pump 18, in particular in a pressure chamber (not shown), wherein the quantity of fuel 12 to which high pressure is applied in the high-pressure fuel pump 18 can be set by appropriate active actuation of an inlet valve 20. Via a high-pressure port 22 on a pump housing 24 of the high-pressure fuel pump 18, the highly pressurized fuel 12 is then fed to a high-pressure accumulator 26, on which injectors 28 are arranged via which the highly pressurized and stored fuel 12 can be injected into combustion chambers of an internal combustion engine.

FIG. 2 shows a cross-sectional illustration of the high-pressure port 22 from FIG. 1 in a plan view as seen from the high-pressure accumulator 26. Introduced into the high-pressure port 22 is a line bore 30, via which fuel 12 can be delivered from the high-pressure fuel pump 18 to the high-pressure accumulator 26. Arranged in the line bore 30 is a valve arrangement 32, which has an outlet valve 34 and a pressure-limiting valve 36. Visible in the plan view in FIG. 2 are an outlet valve element 38 of the outlet valve and a pressure-limiting valve element 40 of the pressure-limiting valve 36.

It is also apparent that the line bore 30 has a bore region 42 with a smaller cross section and a bore region 44 with a larger cross section, which is provided by symmetrically arranged indentations 46. This results in a flower-shaped cross-sectional form. The flower-shaped cross-sectional form of the line bore 30 with the indentations 46 ensures that the fuel 12 can flow easily and without changes in direction into the high-pressure accumulator 26 with the outlet valve 34 open.

FIG. 3 shows an illustration of the high-pressure port 22 from FIG. 2 in longitudinal section along the line III-III, i.e. as a longitudinal section through the bore region 42 with a smaller diameter. In the high-pressure port 22, the outlet valve 34 and the pressure-limiting valve 36 are arranged coaxially one after the other. In this case, the outlet valve 34 has the outlet valve element 38, wherein an outlet valve seat 48 with which the outlet valve element 38 cooperates in order to close the outlet valve 34 is formed on a valve plate 50, which is fastened in the line bore 30 of the high-pressure port 22 for example by pressing. The valve plate 50 has a passage opening 52, through which, with the outlet valve 34 open, the highly pressurized fuel 12 can flow out of the high-pressure fuel pump 18 and into the high-pressure accumulator 26. The outlet valve element 38 closes this passage opening 52 when the outlet valve element 38 is closed.

The outlet valve 34 accordingly opens along a longitudinal axis 54 of the high-pressure port 22 in a first direction R₁ away from the high-pressure fuel pump 18 to the high-pressure accumulator 26. The pressure-limiting valve element 40 cooperates with a pressure-limiting valve seat 56 in order to close the pressure-limiting valve 36. In this case, the pressure-limiting valve seat 56 is provided by the outlet valve element 38. To this end, the outlet valve element 38 has a central flow-through opening 58, which is closed by the pressure-limiting valve element 40 in a closed state of the pressure-limiting valve 36.

The passage opening 52 in the valve plate 50 has a larger diameter than the flow-through opening 58 in the outlet valve element 38. Thus, different flow cross sections are realized for the outlet valve 34 and the pressure-limiting valve 36, and different opening pressures can be set. The pressure-limiting valve 36 likewise opens along the longitudinal axis 54, but in a second direction R₂ opposite to the first direction R₁ when fuel 12 flows from the high-pressure accumulator 26 in the direction of the high-pressure fuel pump 18.

Both the outlet valve element 38 and the pressure-limiting valve element 40 are each preloaded onto their valve seats 48, 56 by a spring. The outlet valve element 38 is in this case preloaded onto the valve plate 50 into the closed position by an outlet valve compression spring 60, which is supported at one end on a shoulder 62 in the high-pressure port 22. With regard to the outlet valve element 38, the pressure-limiting valve element 40 is located opposite a pressure-limiting valve compression spring 64, which pulls the pressure-limiting valve element 40 onto the outlet valve element 38 in the closed position.

The outlet valve compression spring 60 and the pressure-limiting valve compression spring 64 are accordingly arranged coaxially and one after the other along the longitudinal axis 54 on the same side in the line bore 30 of the high-pressure port 22. Located between them is a support plate 66, on which the two springs 60, are supported with one end. Accordingly, the outlet valve compression spring 60 is supported with one end on the shoulder 62 and with the other end on the support plate 66, while the pressure-limiting valve compression spring 64 is supported with one end on the support plate 66 and with the other end on the outlet valve element 38.

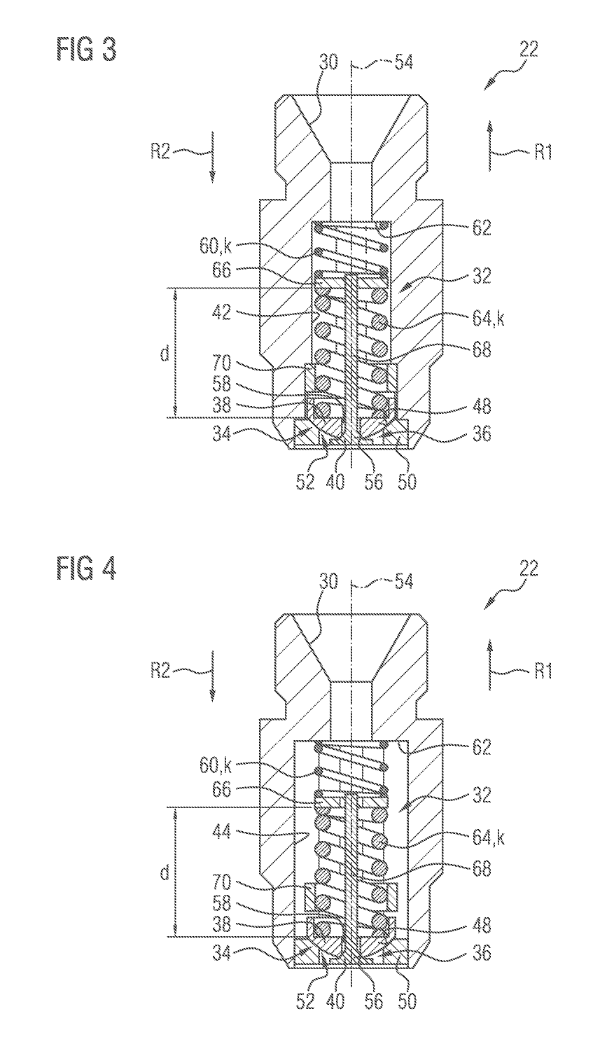

To apply the spring force of the pressure-limiting valve compression spring 64 to the pressure-limiting valve element 40, the pressure-limiting valve element 40 is formed in one piece with a pin 68, which engages through the through-flow opening 58 in the outlet valve element 38 and is coupled to the support plate 66. This can take place for example by pressing, welding, screwing or crimping. The pressure-limiting valve compression spring 64 has a greater spring force F than the outlet valve compression spring 60. In this case, the spring force F of the pressure-limiting valve compression spring 64 is large enough for the support plate 66 and the outlet valve element 38 to be kept at a constant spacing d in the case of a pressure difference between the high-pressure fuel pump 18 and the high-pressure accumulator 26 of up to 100 bar. FIG. 4 shows an illustration of the high-pressure port 22 from FIG. 2 in a view in longitudinal section along the line IV-IV, i.e. where the line bore 30 has the greatest diameter and the indentations 46 are present. It is apparent from a comparison of FIG. 3 and FIG. 4 that a stop 70 for the outlet valve element is additionally provided in the line bore 30, said stop 70 limiting the movement of the outlet valve element 38 along the longitudinal axis 54. This stop 70 is in this case fastened in the line bore 30 in the bore region 42 with the smaller diameter, for example by being pressed in. Therefore, it is arranged at a distance from a wall of the line bore 30 in FIG. 4 in the sectional view through the indentations 46.

During operation, the valve arrangement 32 functions as follows:

In the high-pressure fuel pump 18, high pressure is applied to the fuel 12. As soon as a pressure that creates a pressure difference in a range between 10 bar and 50 bar between the high-pressure accumulator 26 and the pressure chamber (not shown) of the high-pressure fuel pump 18 has been generated in the pressure chamber, the spring force F of the outlet valve compression spring 60, which is very low, is overcome, the outlet valve compression spring 60 is compressed, and the outlet valve element 38 is opened maximally as far as the stop 70 and thus clears a flow cross section, namely the passage opening 52. The highly pressurized fuel 12 can then flow from the pressure chamber into the high-pressure accumulator 26. The spring force F of the outlet valve compression spring 60 is kept very low, in order that the outlet valve compression spring 60 is already compressed at a very low pressure difference, in order for it to be possible to achieve the greatest possible efficiency of the high-pressure fuel pump 18.

By contrast, the spring force F of the pressure-limiting valve compression spring 64 is very large. This has the effect that the pressure difference between the pressure chamber and the high-pressure accumulator 26 is insufficient to be able to compress the pressure-limiting valve compression spring 64, because the outlet valve 34 opens before this can occur. As a result, the support plate 66 and the outlet valve element 38 are kept at a constant spacing d, and the pressure-limiting valve element 40 remains securely in its pressure-limiting valve seat 56, which is formed by the outlet valve element 38.

If the high-pressure fuel pump 18 is not in a pump stroke and thus the pressure chamber (not shown) is pressure-free, the outlet valve element 38 returns into its closed position on the outlet valve seat 48 as a result of the spring force F of the outlet valve compression spring 60. If, in this operating state, an undesired excess pressure arises in the high-pressure accumulator 26, which considerably exceeds a high pressure in the fuel 12 of for example 350 bar, a pressure difference of about 300 bar to 400 bar prevails over the valve arrangement 32. This pressure difference is sufficient to overcome the very high spring force F of the pressure-limiting valve compression spring 64 and to lift the pressure-limiting valve element 40 out of its pressure-limiting valve seat 56. As a result, a small flow cross section, formed by the flow-through opening 58 in the outlet valve element 38, is cleared, excess fuel 12 can flow out of the high-pressure accumulator 26 back into the high-pressure fuel pump 18 and as a result is discharged from the high-pressure accumulator 26. As a result, the excess pressure in the high-pressure accumulator 26 can be reduced.

1. A high-pressure port for a high-pressure fuel pump of a fuel injection system, the port comprising:
an outlet valve with an outlet valve element opening in a first direction and cooperating with an outlet valve seat to close the outlet valve; and
a pressure-limiting valve with a pressure-limiting valve element opening in a second direction opposite the first direction and cooperating with a pressure-limiting valve seat to close the pressure-limiting valve;
wherein the outlet valve element comprises the pressure-limiting valve seat.

2. The high-pressure port as claimed in claim 1, wherein the outlet valve and the pressure-limiting valve are arranged coaxially one after the other in the high-pressure port.

3. The high-pressure port as claimed in claim 1, wherein:
the outlet valve seat is formed in a valve plate pressed into the high-pressure port;
the valve plate comprises a central passage opening blocked by the outlet valve element in a closed position of the outlet valve element.

4. The high-pressure port as claimed in claim 1, wherein:
the outlet valve element comprises a central flow-through opening blocked by the pressure-limiting valve element in a closed position of the pressure-limiting valve element; and
the passage opening in the valve plate has a larger diameter than the flow-through opening in the outlet valve element.

5. The high-pressure port as claimed in claim 1, further comprising:
an outlet valve compression spring for preloading the outlet valve element onto the outlet valve seat;
a pressure-limiting valve compression spring for preloading the pressure-limiting valve element onto the pressure-limiting valve seat;
wherein the outlet valve compression spring and the pressure-limiting valve compression spring are arranged coaxially and one after the other; and
a plate supporting both the outlet valve compression spring and the pressure-limiting valve compression spring arranged between the outlet valve compression spring and the pressure-limiting valve compression spring.

6. The high-pressure port as claimed in claim 5, further comprising a shoulder in a body of the port, the shoulder supporting the outlet valve compression spring; and
wherein the pressure-limiting valve compression spring is supported on the outlet valve element.

7. The high-pressure port as claimed in claim 5, wherein:
the pressure-limiting valve compression spring has a greater spring force than the outlet valve compression spring; and
the pressure-limiting valve compression spring force is large enough for the pressure-limiting valve compression spring to keep the outlet valve element and the support plate at a constant spacing in the case of a pressure difference, acting via the outlet valve, of up to 100 bar.

8. The high-pressure port as claimed in claim 5, wherein:
the pressure-limiting valve element is arranged opposite the pressure-limiting valve compression spring and the outlet valve compression spring with regard to the outlet valve element; and
the pressure-limiting valve element is coupled to the support plate by a pin that engages through the outlet valve element.

9. A high-pressure fuel pump for applying high pressure to a fuel in a fuel injection system of an internal combustion engine, having a pump housing, the fuel pump comprising:
a pump housing in which high pressure is applied to the fuel; and
a high-pressure port fastened to the pump housing, the port comprising:
an outlet valve with an outlet valve element opening in a first direction and cooperating with an outlet valve seat to close the outlet valve; and
a pressure-limiting valve with a pressure-limiting valve element opening in a second direction opposite the first direction and cooperating with a pressure-limiting valve seat to close the pressure-limiting valve;
wherein the outlet valve element comprises the pressure-limiting valve seat.
